(19) United States
(12) Patent Application Publication
(10) Pub. No.: US 2026/0359010 A1
(43) Pub. Date: Nov. 12, 2026

(54) QUANTUM RANDOM NUMBER GENERATION YIELDING TWO TYPES OF RANDOM NUMBERS

(71) Applicant: Cisco Technology, Inc., San Jose, CA (US)

(72) Inventors: Jiapeng ZHAO, Kenmore, WA (US); Michael John KILZER, Los Angeles, CA (US); Hassan SHAPOURIAN, San Mateo, CA (US); Eneet KAUR, Somerville, MA (US); Ramana Rao V. R. KOMPELLA, Foster City, CA (US)

(73) Assignee: Cisco Technology, Inc., San Jose, CA (US)

(21) Appl. No.: 18/588,074

(22) Filed: Feb. 27, 2024

(51) Int. Cl. G06F 7/58

(52) U.S. Cl. CPC G06F 7/58

(57) ABSTRACT

In one embodiment, a method for quantum random number generation yielding two types of random numbers is disclosed. The method includes generating a first signal based on a first value corresponding to a first quadrature of a quantum vacuum state and a first input from a local oscillator and generating a second signal based on a second value corresponding to a second quadrature of the quantum vacuum state and a second input from the local oscillator. The method further includes sampling the first signal to generate a first sampled signal, sampling the second signal to generate a second sampled signal, and deskewing the first sampled signal and the second sampled signal to generate a first random number and a second random number concurrently.

### TECHNICAL FIELD

The present disclosure relates generally to computer networks, and, more particularly, to quantum random number generation concurrently yielding two types of random numbers.

### BACKGROUND

Random numbers are used for a wide variety of purposes ranging from cryptography to telecommunications, among others. Recently, efforts to generate random numbers have focused on leveraging quantum mechanical effects found in nature as a source of entropy for purposes of number generation.

In general, quantum random number generators can only generate one type of random number at a time, typically being either a uniform random number (URN) or Rayleigh random number (RRN), depending on the system. However, both URNs and RRNs have significant impacts in many application scenarios including financial simulations, scientific research, artificial intelligence and machine learning, environmental and weather simulations, cryptography, as well as gaming and gambling. A high-quality random number with the correct type not only guarantees accurate prediction and simulation, but also provides more efficient calculation and information processing.

If one type of random number is desired, but the quantum source can only provide the other type of random number, output bits of the generated number will need to be sacrificed in order to convert the number into the desired type. For example, in a vacuum-based quantum random number generator, measuring one quadrature generates a Gaussian random number (GRN). However, if a URN is desired, additional postprocessing may be required, which further leads to a decreased bit rate and, hence a lower precision in the output bit string.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example system;

FIG. 2 illustrates an example plot representing Gaussian distributed random variables in phase space;

FIG. 3 illustrates an example functional block diagram of a system for quantum random number generation yielding two types of random numbers in accordance with the present disclosure; and

FIG. 4 illustrates an example procedure for quantum random number generation yielding two types of random numbers in accordance with the present disclosure.

### DESCRIPTION OF EXAMPLE EMBODIMENTS

### Overview

According to one or more embodiments of the disclosure, a method includes generating a first signal based on a first value corresponding to a first quadrature of a quantum vacuum state and a first input from a local oscillator and generating a second signal based on a second value corresponding to a second quadrature of the quantum vacuum state and a second input from the local oscillator. The method further includes sampling the first signal to generate a first sampled signal, sampling the second signal to generate a second sampled signal, and deskewing the first sampled signal and the second sampled signal to generate a first random number and a second random number.

Other implementations are described below, and this overview is not meant to limit the scope of the present disclosure.

### DESCRIPTION

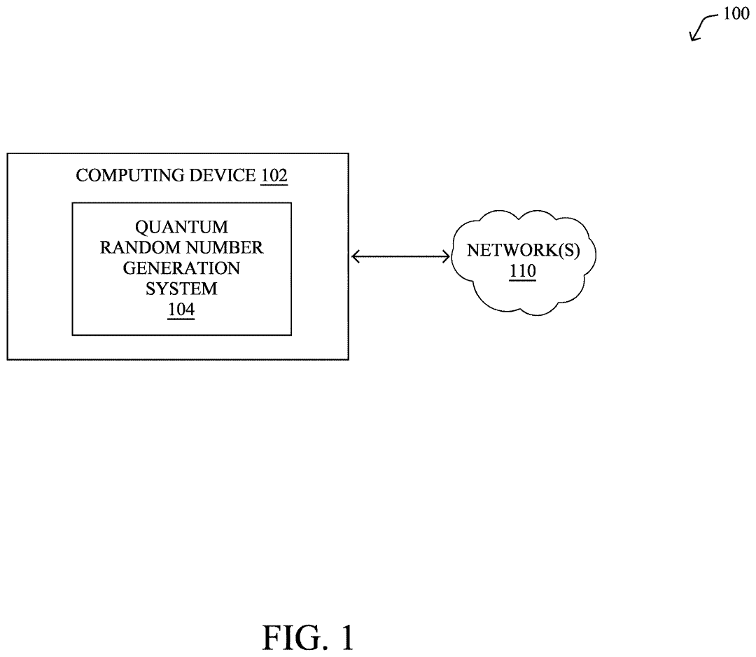

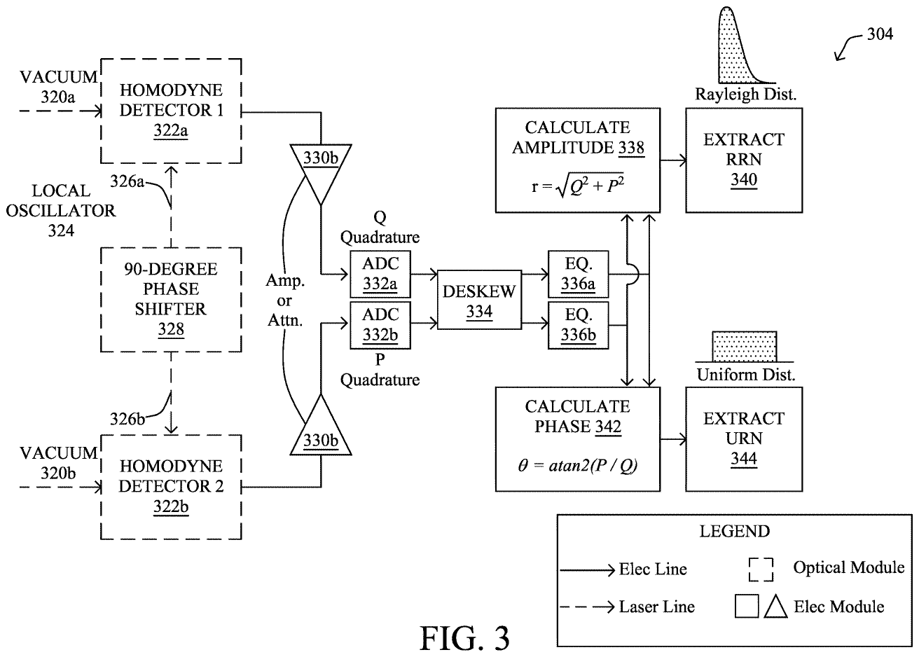

FIG. 1 illustrates an example system. The example system of FIG. 1 can be a computing system 100 that includes a computing device 102 that includes a quantum random number generation system 104. As discussed in more detail below, the quantum random number generation system 104 can be analogous to the quantum random number generation system 304 of FIG. 3. As shown in FIG. 1, the computing device 102 can be communicatively coupled to network(s) 110.

Although shown as being a part of the computing device 102 and, hence, part of the computing system 100, the quantum random number generation system 104 can be a separate physical system that is communicatively coupled to the computing system 100 and/or the computing device 102. For example, in some implementations, the quantum random number generation system 104 can be an integrated circuit deployment, such as a set of circuit components on a die (e.g., a set of circuit components deployed on a silicon substrate), a system-on-chip, standalone integrated unit, or other such apparatus or system in which the components of the quantum random number generation system 104 may be located. Further, in some implementations, the components of the quantum random number generation system 104 may be co-located on one or more such die, systems-on-chip, or standalone integrated units, among other possibilities.

Although not shown in FIG. 1 so as to not obfuscate the illustration, the computing system 100 can further include any number of client devices, one or more servers, and one or more databases. These devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data according to predefined protocols, such as the Transmission Control Protocol/Internet Protocol (TCP/IP) other suitable data structures, protocols, and/or signals.

The aforementioned client devices may include any number of user devices or end point devices configured to interface with the techniques herein. For example, client devices may include, but are not limited to, the computing device 102, which can be a desktop computer, laptop computer, tablet device, smart phone, wearable device (e.g., heads up device, smart watch, etc.), set-top device, smart television, Internet of Things (IoT) device, autonomous device, or any other form of computing device capable of participating with other devices via network(s) 110.

The servers and/or databases, including any number of other suitable devices (e.g., firewalls, gateways, and so on) may be part of a cloud-based service. In such cases, the servers and/or databases may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in the computing system 100, and that the view shown herein is for simplicity. Also, those skilled in the art will further understand that while the network is shown in a certain orientation, the computing system 100 is merely an example illustration that is not meant to limit the disclosure.

### Quantum Random Number Generation Yielding Two Types of Random Numbers

The techniques herein are directed to a quantum random number generator that can generate both uniform random number (URNs) and Rayleigh random numbers (RRNs), among other random numbers, such as Gaussian random numbers, etc. simultaneously.

Random numbers are used for a wide variety of purposes ranging from cryptography to telecommunications, among others. Recently, efforts to generate random numbers have focused on leveraging quantum mechanical effects found in nature as a source of entropy for purposes of number generation.

State of the art quantum random number generators can only generate one type of random number at a time, typically being either a uniform random number (URN) or Rayleigh random number (RRN), depending on the system. However, as noted above, both URNs and RRNs have significant impacts in many application scenarios including telecommunications, financial simulations, scientific research, artificial intelligence and machine learning, environmental and weather simulations, cryptography, as well as gaming and gambling. A high-quality random number with the correct type not only guarantees accurate prediction and simulation, but also provides more efficient calculation and information processing.

In current approaches, if one type of random number is desired, but the quantum source can only provide the other type of random number, output bits of the generated number will need to be sacrificed in order to convert the number into the desired type.

For example, in a vacuum-based quantum random number generator, measuring one quadrature generates a GRN. However, if a URN is desired, additional postprocessing is required, which further decreases the bit rate and/or lowers the precision of the output bit string.

Specifically, according to one or more embodiments of the disclosure as described in detail below, a method includes generating a first signal based on a first value corresponding to a first quadrature of a quantum vacuum state and a first input from a local oscillator and generating a second signal based on a second value corresponding to a second quadrature of the quantum vacuum state and a second input from the local oscillator. The method further includes sampling the first signal to generate a first sampled signal, sampling the second signal to generate a second sampled signal, and deskewing the first sampled signal and the second sampled signal to generate a first random number and a second random number.

It will be appreciated that the techniques described herein may be performed by hardware, software, and/or firmware.

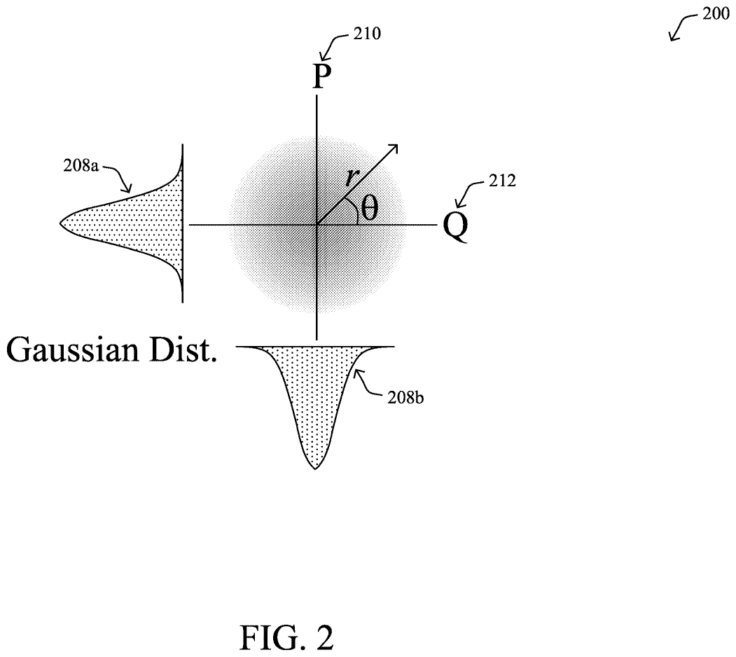

FIG. 2 illustrates an example plot representing Gaussian distributed random variables in phase space. In FIG. 2, the plot 200 illustrates a two-dimensional phase space with quadratures representing the coordinates of the two-dimensional phase space. In the non-limiting example shown in FIG. 2, quadrature operators (e.g., the quadrature operators P and Q) may represent coordinates of the plot 200. For example, as shown in FIG. 2, the quadrature operator Q may represent an X coordinate of a generalized two-dimensional plot, while the operator P may represent a Y coordinate of a generalized two-dimensional plot, as discussed in more detail below.

Stepping back for a moment, in quantum mechanics, a quantum vacuum state (or “vacuum state” for brevity) refers to a quantum state where no particle is excited in the quantum field. That is, the quantum vacuum state refers to a quantum state that exhibits a lowest theoretical energy and, as a consequence, does not contain physical particles. Accordingly, the expectation value, i.e., the mean value of the electric field operator in a quantum vacuum state, should therefore be zero. However, fluctuations in the quantum field can create noise, which may be introduced by fleeting electromagnetic waves and/or particles that pop into the quantum field. This noise can cause the energy of the vacuum state to be non-zero in accordance with generally understood and accepted principles of physics.

In general, it is usually convenient to define quadrature operators to describe the evolution of complex fields in optics. Similarly in quantum optics, it is generally convenient to define two quadrature operators, such as the generalized operators Q and P shown in FIG. 2, to describe the evolution of a quantized electric field. As a result, and in accordance with the disclosure, when the fluctuations (e.g., the noise mentioned above) of electric field operators in the quantum vacuum state are calculated, the calculation may involve calculation of fluctuations of the Q and/or P operators shown in FIG. 2.

As will be appreciated, the fluctuations of both the operators Q and P are Gaussian distributed random variables (e.g., the Gaussian distributions 208a and 208b) that are centered at zero with respect to the plot 200 with a variance of ¼ in shot noise units. As discussed in more detail herein, this randomness can be leveraged as the source to extract quantum random numbers.

In optics, phase space is generally viewed as a two-dimensional space, illustrated by the plot 200, consisting of quadratures as the coordinates, as shown in FIG. 2. As mentioned above, in FIG. 2, the quadrature operator Q corresponds to the X coordinate of the two-dimensional space and the quadrature operator P corresponds to the Y coordinate of the two-dimensional space. In this phase space representation, the vacuum noise follows a two-dimensional Gaussian distribution (e.g., the Gaussian distributions 208a and 208b). Thus, by calculating the phase angle θ and the amplitude r of each measured Q and P pair, it may be determined that the phase angle θ is a random variable following uniform distribution, while the amplitude r is a random variable following Rayleigh distribution. Accordingly, by measuring the Q and P quadratures of the vacuum state simultaneously using the double homodyne configuration shown in FIG. 2, implementations of the present disclosure allow for the generation of both Rayleigh random numbers (RRNs) and uniform random numbers (URNs). It is noted that, without synchronizing the measurement results of the Q and P quadratures, the present disclosure allows for the generation of Gaussian random numbers (GRNs) as well.

Moreover, implementations of the present disclosure allow for the generation of both RRNs and URNs concurrently or substantially concurrently. In some implementations, the RRNs and URNs can be generated concurrently or substantially concurrently from a single vacuum state input (e.g., a single Q, P pair), although implementations are not so limited.

Operationally, FIG. 3 illustrates an example functional block diagram of a system for quantum random number generation yielding two types of random numbers in accordance with the present disclosure. The system can be referred to in the alternative as a quantum random number generation system 304 and can be analogous to the quantum random number generation system 104 of FIG. 1. Further, the quantum random number generation system 304 may be referred to herein in the alternative as an “apparatus” or a “quantum random number generation apparatus.”

As shown in FIG. 3, and in contrast to current approaches that provide a single homodyne detector, the quantum random number generation system 304 includes a first homodyne detector 322a and a second homodyne detector 322b. In some implementations, the first homodyne detector 322a and the second homodyne detector 322b are used by the quantum random number generation system 304 to measure two quadratures concurrently (e.g., simultaneously).

The first homodyne detector 322a can receive, as a first input, a first quantum vacuum 320a and the second homodyne detector 322b can receive, as a first input, a second quantum vacuum 320b. The first quantum vacuum 320a can be the same as the second quantum vacuum 320b (e.g., the first input and the second input can be received from a single quantum vacuum state and may therefore have a same value, same sampling time, etc.). Accordingly, the first quantum vacuum 320a and the second quantum vacuum 320b can be “fully blocked” inputs. Further, the first homodyne detector 322a can receive, as a second input, a first strong laser input 326a and the second homodyne detector 322b can receive, as a second input, a second strong laser input 326b.

The first strong laser input 326a and the second strong laser input 326b can be received as a local oscillator 324. That is, a laser source can be used as the local oscillator 324 and this input can be provided to the first homodyne detector 322a and the second homodyne detector 322b. Because the quadrature Q and the quadrature P are 90° out of phase, the phase of the local oscillator 324 can be delayed, for example using the 90-degree phase shifter 328 by 90° so that phase of the quadrature Q and the quadrature P are matched. The 90-degree phase shifter 328 can be a hardware component, such as a circuit component that can be configured to shift the phase of the output generated by the first homodyne detector 322a and/or the output generated by the second homodyne detector 322b to match the phases of such outputs. In some implementations, both laser inputs (i.e., the first strong laser input 326a and the second strong laser input 326b) are optically synchronized at the corresponding homodyne detectors (e.g., the first homodyne detector 322a and the second homodyne detector 322b) so that the phases of the laser inputs are matched.

Although the 90-degree phase shifter 328 (or “phase shifter, for brevity) is illustrated as being coupled to both the homodyne detectors, it will be appreciated that, in general, the phase shifter may only operate in connection with one of the homodyne detectors at a time. For example, the 90-degree phase shifter 328 may operate to shift the phase of the Q quadrature to match the phase of the P quadrature, or vice versa. In implementations in which the 90-degree phase shifter 328 operates to shift the phase of the Q quadrature, the local oscillator 324 may be directly coupled to the first homodyne detector 322a and the local oscillator 324 may be coupled to the 90-degree phase shifter 328, which is, in turn coupled to the second homodyne detector 322b. Similarly, in implementations in which the 90-degree phase shifter 328 operates to shift the phase of the P quadrature, the local oscillator 324 may be directly coupled to the second homodyne detector 322b and the local oscillator 324 may be coupled to the 90-degree phase shifter 328, which is, in turn coupled to the first homodyne detector 322a. Implementations are not so limited, however, and other implementations contemplated herein can allow for the components to be coupled in various other manners.

Subsequent to homodyne detection, the electrical outputs (e.g., the signals output by the first homodyne detector 322a and the second homodyne detector 322b) can be amplified or attenuated using, for example, the first amplification/attenuation component 330a and the second amplification/attenuation component 330b. This amplification or attenuation can be provided to the signals such that the signals can exercise the full scale of the analog-to-digital converters (e.g., the first analog-to-digital converter 332a and the second analog-to-digital converter 332b) without saturating the analog-to-digital converters.

As shown in FIG. 3, these signals (e.g., the amplified or attenuated signals output from the homodyne detectors) are then respectively sampled by the first analog-to-digital converter 332a and the second analog-to-digital converter 332b. That is, the amplified or attenuated signal from the first homodyne detector 322a is sampled by the first analog-to-digital converter 332a and the amplified or attenuated signal from the second homodyne detector 322b is sampled by the second analog-to-digital converter 332b. This quantizes the analog signals from the homodyne detectors to digital values for processing. It is noted that the Q and P quadrature values are the real and imaginary components, respectively, of the detected signal in the complex number plane.

After the signals are sampled by the first analog-to-digital converter 332a and the second analog-to-digital converter 332b, Q and P quadratures are deskewed at block 334. In general, the deskewing perform at block 334 ensures that the received Q and P quadrature samples are temporally aligned, and the equalization counteracts correlations in time between sequential samples.

As shown in FIG. 3, the deskewed signals are then respectively processed by digital equalization filters (e.g., the first equalization filter 336a and the second equalization filter 336b). That is, the deskewed signal that was sampled by the first analog-to-digital converter 332a is processed by the first equalization filter 336a and the deskewed signal that was sampled by the second analog-to-digital converter 332b is processed by the second equalization filter 336b.

Each Q and P quadrature pair then is used to calculate the amplitude and phase of the Q and P quadrature pair in the phase space. As shown in FIG. 3, the amplitude of each Q and P quadrature pair is calculated at block 338 while the phase of each Q and P quadrature pair is calculated at block 342. The relation between cartesian coordinates and polar coordinates for complex numbers allows the system to calculate the phase angle and amplitude of each measured Q and P quadrature pair. The amplitude is calculated electronically using the well-known Pythagorean theorem shown in Equation 1:

a²+b²=c² Equation 1

where a corresponds to the Q quadrature, b corresponds to the P quadrature, and c corresponds to the amplitude, r. By taking the square root and substituting the Q quadrature and the P quadrature for a and b, respectively, we arrive at Equation 2, which provides a solution for the amplitude, r:

r=\sqrt{Q²+P²} Equation 2

The phase angle is calculated electronically using the atan 2 function, shown in Equation 3:

$$θ = atan 2 ( \frac{b}{a} ) \qquad Equation 3$$

where a corresponds to the Q quadrature, b corresponds to the P quadrature, and θ corresponds to the phase angle. It is noted that it is important to use the atan 2 function as opposed to the atan function so that all possible angles −π to +π can be recovered rather than just

$$- \frac{π}{2} to + \frac{π}{2} .$$

Substituting the Q quadrature and the P quadrature for a and b, respectively, we arrive at Equation 4:

$$θ = atan 2 ( \frac{P}{Q} ) \qquad Equation 4$$

which can be used to calculate the phase angle.

As shown in FIG. 3, the phase angle distribution can be used to extract a uniform random number (URN) as shown at block 344, while the amplitude distribution can be used to extract a Rayleigh random number (RRN) as shown at block 340. It is noted that the extraction of the URN and RRN discussed herein have been verified via simulation, as indicated by the plots above block 340 and block 344 illustrated in FIG. 3.

It is noted that the data generated by the quantum random number generation system 304 can include noise. However, this noise can be characterized, and the sources of the noise can be identified and understood. This knowledge of the noise along with knowledge of the Q quadrature value and the P quadrature value can be used to generate a probability distribution associated with observed data behavior of the quantum random number generation system 304.

Leveraging this probability distribution, the min-entropy, which is a well-known information theory quantity, can be calculated. As will be appreciated, the min-entropy (in bits) of a random variable X is the largest value m having the property that each observation of X provides at least m bits of information (i.e., the min-entropy of X is the greatest lower bound for the information content of potential observations of X). The min-entropy of a random variable is a lower bound on its entropy. The precise formulation for min-entropy is (log 2 max pᵢ) for a discrete distribution having n possible outputs with probabilities p₁, . . . , pₙ. Min-entropy is often used as a worst-case measure of the unpredictability of a random variable. In some implementations, the min-entropy can later be used to optimize the security parameter and the length of the output string of the randomness extractor described below.

In order to extract randomness from the noisy data mentioned above, various types of randomness number extractors may be used. One type of randomness number extractors is called the multi-source randomness number extractor. This extractor takes as input two weak random strings, and outputs an almost informational theoretically secure random string. This extractor is, in general, limited in its bit string rate and performs a one-time operation to obtain a uniform seed, as the uniform seed can be reused without reducing the security of the seed substantially.

In some implementations, the aforementioned uniform seed may be used for a seeded extractor. These extractors take in as input the seed and the weak random string to output a near perfect random string. This near perfect uniform random or Rayleigh distributed strings may be the final random numbers generated in accordance with the disclosure that may be used subsequently for the various application described herein, such as telecommunications, financial simulations, scientific research, artificial intelligence and machine learning, environmental and weather simulations, cryptography, as well as gaming and gambling.

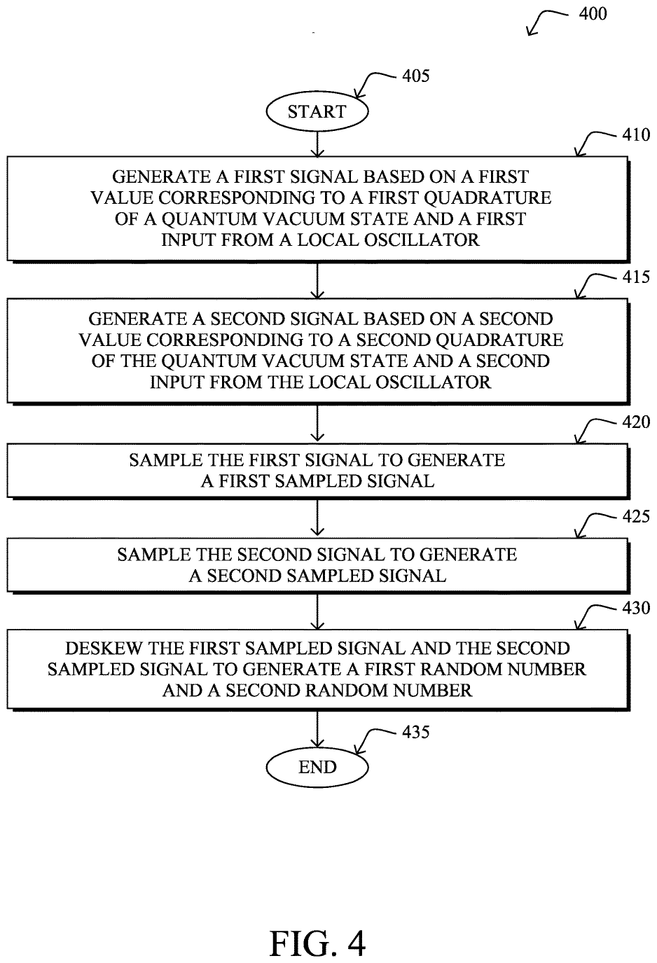

FIG. 4 illustrates an example simplified procedure for quantum random number generation yielding two types of random numbers in accordance with one or more embodiments described herein. For example, a non-generic, specifically configured device (e.g., the quantum random number generation system 304) may perform procedure 400 by performing operations and/or executing stored instructions. The procedure 400 may start at step 405, and continues to step 410, where, as described in greater detail above, a first signal based on a first value corresponding to a first quadrature of a quantum vacuum state and a first input from a local oscillator is generated by a device. In some implementations, the first signal is generated by a first homodyne detector.

The procedure 400 may continue to step 415 where, as described in greater detail above, a second signal based on a second value corresponding to a second quadrature of the quantum vacuum state and a second input from the local oscillator is generated by the device. In some implementation, the second signal is generated by a second homodyne detector.

As discussed above, fluctuations of the first quadrature and fluctuations of the second quadrature may be associated with Gaussian distributed random variables, although possibilities are not limited to this specifically enumerated distribution.

The procedure 400 may continue to step 420 where, as described in greater detail above, the first signal is sampled using the device to generate a first sampled signal. In some implementations, the first signal is sampled using a first analog-to-digital converter.

The procedure 400 may continue to step 425 where, as described in greater detail above, the second signal is sampled using the device to generate a second sampled signal. In some implementations, the second signal is sampled using a second analog-to-digital converter.

As discussed above, the first signal and/or the second signal may be amplified or attenuated prior to being sampled by, for example, the first analog-to-digital converter and/or the second analog-to-digital converter.

The procedure 400 may continue to step 430 where, as described in greater detail above, the first sampled signal and the second sampled signal are deskewed to generate a first random number and a second random number. As discussed above, the deskewing may ensure that the first value corresponding to the first quadrature and the second value corresponding to the second quadrature are temporally aligned.

In some implementations, the first random number can be a uniform random number and the second random number can be a Rayleigh random number. Further, as discussed above, the first random number and the second random number can be generated concurrently (e.g., simultaneously). In addition, the first random number and the second random number can be generated from the same quantum vacuum state, such as the vacuum illustrated in FIG. 3, although implementations are not so limited.

As described above, generating the second random number can include calculating an amplitude distribution of the second sampled signal subsequent to deskewing and generating the first random number can include calculating a phase angle distribution of the first sampled signal subsequent to deskewing. Implementations are not so limited, however, and in some implementations, depending on the definitions of the variables discussed herein, generating the first random number can include calculating an amplitude distribution of the second sampled signal subsequent to deskewing and generating the second random number can include calculating a phase angle distribution of the first sampled signal subsequent to deskewing.

The procedure 400 can further include processing the first sampled signal and the second sampled signal using respective digital equalization filters subsequent to deskewing to generate the first random number and the second random number, as discussed above.

In addition, the procedure 400 can include using the first random number or the second random number, or both, in an application selected from a list of applications consisting of: a telecommunications application, a financial simulation, a scientific research application, an artificial intelligence application, a machine learning application, an environmental and weather simulation, a cryptography application, a gaming application, and a gambling application. It will be appreciated that examples of applications in which the random numbers that are generated in accordance with the can be used are not so limited and the foregoing are merely non-limiting illustrative examples of such applications.

The procedure 400 may end at step 435.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus, such as the quantum random number generation system 304 herein may comprise: a first homodyne detector 322a coupled to a local oscillator 324, a second homodyne detector 322b coupled to the local oscillator 324, a phase shifter (e.g., the 90-degree phase shifter 328 of FIG. 3) to match a phase between the first and second homodyne detectors, a first analog-to-digital converter 332a coupled to the first homodyne detector 322a, and a second analog-to-digital converter 332b coupled to the second homodyne detector 322b. In such implementations, the first homodyne detector is configured to generate a first signal based on a first value corresponding to a first quadrature of a quantum vacuum state and a first input from a local oscillator, the second homodyne detector is configured to generate a second signal based on a second value corresponding to a second quadrature of the quantum vacuum state and a second input from the local oscillator, the first analog-to-digital converter is configured to sample the first signal to generate a first sampled signal, the second analog-to-digital converter is configured to sample the second signal to generate a second sampled signal, and the apparatus is configured to deskew the first sampled signal and the second sampled signal to generate a first random number and a second random number.

In still other implementations, a tangible, non-transitory, computer-readable medium storing program instructions that cause a device to execute a process comprising: generating a first signal based on a first value corresponding to a first quadrature of a quantum vacuum state and a first input from a local oscillator, generating a second signal based on a second value corresponding to a second quadrature of the quantum vacuum state and a second input from the local oscillator, sampling the first signal to generate a first sampled signal, sampling the second signal to generate a second sampled signal, and deskewing the first sampled signal and the second sampled signal to generate a first random number and a second random number.

The techniques described herein, therefore, provide for quantum random number generation yielding two types of random numbers. As discussed above, these techniques improve generation of random numbers and, particularly the generation of quantum random numbers by providing a quantum random number generator that can generate both URNs and RRNs, simultaneously. Further, these techniques can minimize conversion operations utilized by current approaches that sacrifice precision as a result of generating only one type of quantum random number and therefore rely on converting between RRNs and URNs, and vice versa.

Illustratively, the techniques described herein may be performed by hardware, software, and/or firmware, (e.g., an “apparatus”) such as in accordance with the quantum random number generation system 304, and may include computer-executable instructions executed by one or more processors to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the operations and processes described herein.

While there have been shown and described illustrative implementations above, it is to be understood that various other adaptations and modifications may be made within the intent and scope of the implementations herein. For example, while certain architectures, schemes, workloads, etc., are shown herein, the embodiments herein are not so limited.

Further, it is to be understood that various other adaptations and modifications may be made within the scope of the implementations herein. For example, while certain implementations are described herein with respect to certain types of computing architectures in particular, the techniques are not limited as such and may be used with any computing architecture, generally, in other implementations. In addition, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
generating, by a device, a first signal based on a first value corresponding to a first quadrature of a quantum vacuum state and a first input from a local oscillator;
generating, by the device, a second signal based on a second value corresponding to a second quadrature of the quantum vacuum state and a second input from the local oscillator;
sampling, by the device, the first signal to generate a first sampled signal;
sampling, by the device, the second signal to generate a second sampled signal; and
deskewing, by the device, the first sampled signal and the second sampled signal to generate a first random number and a second random number.

2. The method of claim 1, wherein the first random number is a uniform random number, and the second random number is a Rayleigh random number.

3. The method of claim 1, wherein the first random number and the second random number are generated concurrently.

4. The method of claim 1, wherein deskewing ensures that the first value corresponding to the first quadrature and the second value corresponding to the second quadrature are temporally aligned.

5. The method of claim 1, further comprising:
processing the first sampled signal and the second sampled signal using respective digital equalization filters subsequent to deskewing to generate the first random number and the second random number.

6. The method of claim 1, wherein generating the first signal is by a first homodyne detector and generating the second signal is by a second homodyne detector.

7. The method of claim 1, wherein sampling the first signal uses a first analog-to-digital converter and sampling the second signal uses a second analog-to-digital converter.

8. The method of claim 1, wherein generating the second random number comprises calculating an amplitude distribution of the first sampled signal and second sampled signal subsequent to deskewing.

9. The method of claim 1, wherein generating the first random number comprises calculating a phase angle distribution of the first sampled signal and second sampled signal subsequent to deskewing.

10. The method of claim 1, wherein fluctuations of the first quadrature and fluctuations of the second quadrature are associated with Gaussian distributed random variables.

11. The method of claim 1, further comprising:
amplifying or attenuating the first signal or the second signal, or both, prior to sampling the first signal or the second signal, or both.

12. The method of claim 1, further comprising:
using the first random number or the second random number, or both, in an application selected from a list of applications consisting of: a telecommunications application, a financial simulation, a scientific research application, an artificial intelligence application, a machine learning application, an environmental and weather simulation, a cryptography application, a gaming application, and a gambling application.

13. An apparatus, comprising:
a first homodyne detector coupled to a local oscillator;
a second homodyne detector coupled to the local oscillator;
a phase shifter coupled to the first homodyne detector and the second homodyne detector, the phase shifter configured to match a phase between the first homodyne detector and the second homodyne detector;
a first analog-to-digital converter coupled to the first homodyne detector; and
a second analog-to-digital converter coupled to the second homodyne detector, wherein:
the first homodyne detector is configured to generate a first signal based on a first value corresponding to a first quadrature of a quantum vacuum state and a first input from a local oscillator,
the second homodyne detector is configured to generate a second signal based on a second value corresponding to a second quadrature of the quantum vacuum state and a second input from the local oscillator,
the first analog-to-digital converter is configured to sample the first signal to generate a first sampled signal,
the second analog-to-digital converter is configured to sample the second signal to generate a second sampled signal, and
the apparatus is configured to deskew the first sampled signal and the second sampled signal to generate a first random number and a second random number.

14. The apparatus of claim 13, wherein the first random number is a uniform random number, and the second random number is a Rayleigh random number.

15. The apparatus of claim 13, wherein the first random number and the second random number are generated concurrently.

16. The apparatus of claim 13, wherein deskewing ensures that the first value corresponding to the first quadrature and the second value corresponding to the second quadrature are temporally aligned.

17. The apparatus of claim 13, further comprising:
respective equalization filters configured to process the first sampled signal and the second sampled signal subsequent to deskewing to generate the first random number and the second random number.

18. The apparatus of claim 13, wherein generating the second random number comprises calculating an amplitude distribution of the first sampled signal and second sampled signal subsequent to deskewing.

19. The apparatus of claim 13, wherein generating the first random number comprises calculating a phase angle distribution of the first sampled signal and second sampled signal subsequent to deskewing.

20. A tangible, non-transitory, computer-readable medium storing program instructions that cause a device to execute a process comprising:
generating a first signal based on a first value corresponding to a first quadrature of a quantum vacuum state and a first input from a local oscillator;
generating a second signal based on a second value corresponding to a second quadrature of the quantum vacuum state and a second input from the local oscillator;
sampling the first signal to generate a first sampled signal;
sampling the second signal to generate a second sampled signal; and
deskewing the first sampled signal and the second sampled signal to generate a first random number and a second random number.
